(19) United States
(12) Patent Application Publication
(10) Pub. No.: US 2024/0378081 A1
(43) Pub. Date: Nov. 14, 2024

(54) HOST, STORAGE DEVICE AND DATA PROCESSING METHOD OF HOST AND STORAGE DEVICE

(71) Applicant: SAMSUNG ELECTRONICS CO., LTD., Suwon-si (KR)

(72) Inventors: Yangxu Zhou, XiAn (CN); Fei Dong, XiAn (CN); Kun Xue, XiAn (CN)

(73) Assignee: SAMSUNG ELECTRONICS CO., LTD., Suwon-si (KR)

(21) Appl. No.: 18/387,751

(22) Filed: Nov. 7, 2023

(30) Foreign Application Priority Data
May 10, 2023 (CN) 202310526498.4

(51) Int. Cl. G06F 9/50

(52) U.S. Cl. CPC G06F 9/5016; G06F 9/5033; G06F 9/5038

(57) ABSTRACT

A host, a storage device, and a data processing method of the host and the storage device are disclosed. The data processing method of a storage device includes receiving a query request involving a scan-filter task from a host, determining whether a computing resource within the storage device is saturated, with respect to the scan-filter task, determining whether the storage device is needed to perform a scan-filter operation, based on determining that the computing resource within the storage device is not saturated, performing the scan-filter operation on raw data within the storage device to obtain processed data, based on determining that the storage device is needed to perform the scan-filter operation and transmitting the processed data to the host.

### CROSS-REFERENCE TO RELATED APPLICATION

This application is based on and claims priority under 35 U.S.C. § 119 to Chinese Patent Application No. 202310526498.4 filed on May 10, 2023, in the China National Intellectual Property Administration, the disclosure of which is incorporated by reference herein in its entirety.

### BACKGROUND

### 1. Field

The disclosure relates to data processing, and more particularly, to a host, a storage device, and a data processing method of the host and the storage device.

### 2. Description of Related Art

According to a data processing, Structured Query Language (SQL) query requests are executed in a processor of a host. In the data processing method, first, data is read from a storage device into a memory of the host, then the data is processed (e.g., computational operations) in the processor of the host, and finally, the data is returned to the storage device. As a result, SQL query processing generates a large amount of data movement, consumes bandwidth resources, and creates a computational bottleneck in data query processing by overloading the processor of the host computer as the amount of data increases.

In related art, two methods are provided to address this computational bottleneck. According to a first data processing method, an additional compute unit is used to offload a scanning and/or a filtering operation in SQL queries onto the additional compute unit. However, this first method still suffers from a large amount of data movement, resulting in bandwidth bottlenecks and data transfer delays. Moreover, the additional compute unit consumes host memory resources, cannot scale linearly, and cannot fully utilize a high-speed bandwidth of the storage device. According to a second method, the database scanning and/or filtering operation is offloaded to a computational storage. However, the computational capability of current storage devices is relatively weak, which may cause computational blocking.

### SUMMARY

According to one or more aspects of the disclosure, there is provided a host, a storage device, and a data processing method of the host and the storage device, in which, the host and the storage device co-co-process a scanning and/or a filtering operation based on sampling and filtering.

Thus, according to one or more aspects of the disclosure, the host-storage device co-processing the scan-filter operation based on sampling and filtering can effectively reduce the workload of the processor of the host, increase the efficiency of database query, improve database performance, and near data processing, and intelligent/computing storage devices can reduce unnecessary data movement and accelerate data processing speed.

### BRIEF DESCRIPTION OF DRAWINGS

The above and other aspects of the disclosure will become apparent and more easily understood by the following detailed description in conjunction with the accompanying drawings.

FIG. 1 is a flowchart illustrating a data processing method of a storage device according to an embodiment of the disclosure.

FIG. 2 is a diagram illustrating an example of a typical query sequence.

FIG. 3 is a diagram illustrating a related art example of performing a query operation between a host and a storage device.

FIG. 4 is a diagram illustrating an example of using an FPGA to offload a scan-filter operation.

FIG. 5 is a diagram illustrating an example of using an FPGA to offload a scan-filter operation.

FIG. 6 is a diagram illustrating an example of a computational storage offloading database scan-filter scheme.

FIG. 7 is a flowchart illustrating determining whether a computing resource within a storage device is saturated according to an embodiment of the disclosure.

FIG. 8 is a flowchart illustrating determining whether a computing resource within a storage device is saturated according to an embodiment of the disclosure.

FIG. 9 is a flowchart illustrating determining whether the storage device is needed to perform a scan-filter operation according to an embodiment of the disclosure.

FIG. 10 is a diagram illustrating an example of a sample filtering operation according to an embodiment of the disclosure.

FIG. 11 is a flowchart illustrating performing a scan-filter operation on raw data within a storage device according to an embodiment of the disclosure.

FIG. 12 is a flowchart illustrating performing a scan-filter operation on raw data within a storage device according to an embodiment of the disclosure.

FIG. 13 is a diagram illustrating an example of using a pipeline approach to accelerate computation according to an embodiment of the disclosure.

FIG. 14 is a block diagram illustrating a storage device according to an embodiment of the disclosure.

FIG. 15 is a flowchart illustrating a data processing method of a host according to an embodiment of the disclosure.

FIG. 16 is a block diagram illustrating a host according to an embodiment of the disclosure.

FIG. 17 is a schematic diagram of a system to which a storage device is applied according to an embodiment.

FIG. 18 is a block diagram of a storage system according to an embodiment of the disclosure.

FIG. 19 is a block diagram of a storage system according to an embodiment of the disclosure.

FIG. 20 is a block diagram of a host storage system according to an exemplary embodiment.

FIG. 21 is a block diagram of a data center to which a storage device is applied according to an embodiment of the disclosure.

Throughout the drawings and the detailed description, the same figure reference numerals will be understood to refer to the same elements, features and structures unless described or provided otherwise. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all example embodiments are not limited thereto.

The embodiments of the disclosure are example embodiments, and thus, the disclosure is not limited thereto and may be realized in various other forms. As is traditional in the field, embodiments may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

### Embodiments of the Disclosure Will be Described Below in Detail with Reference to the Accompanying Drawings

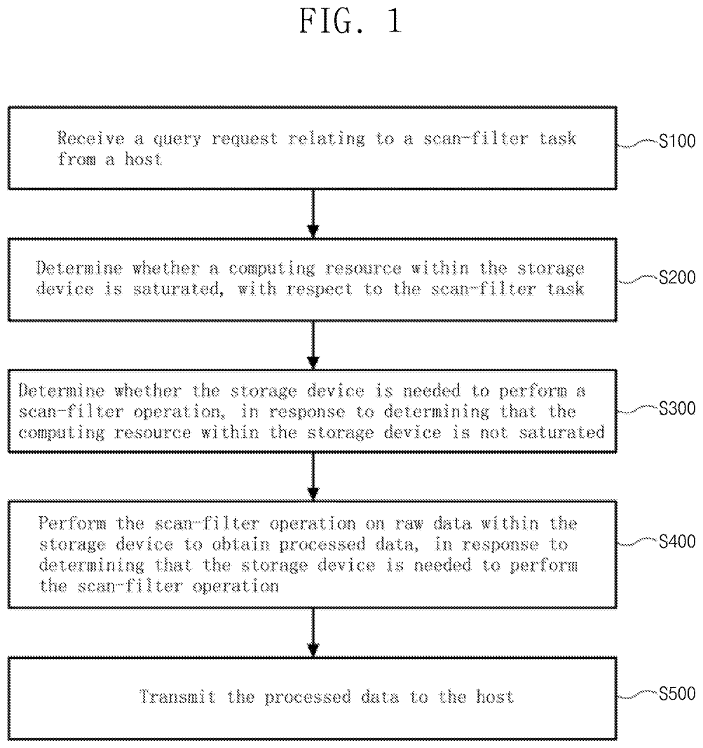

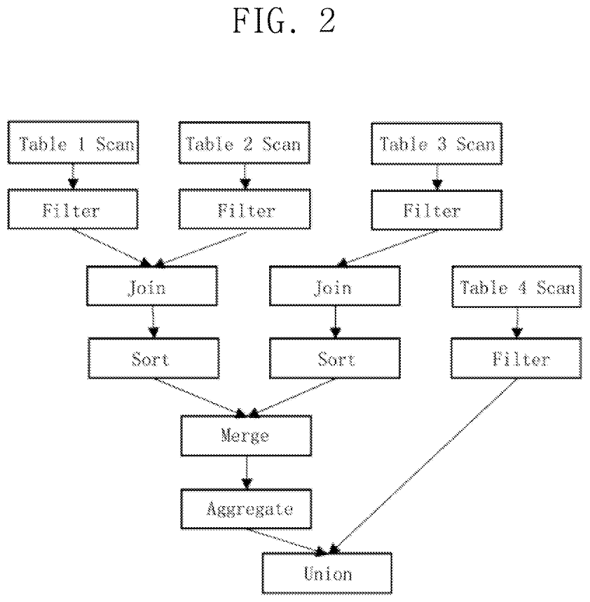

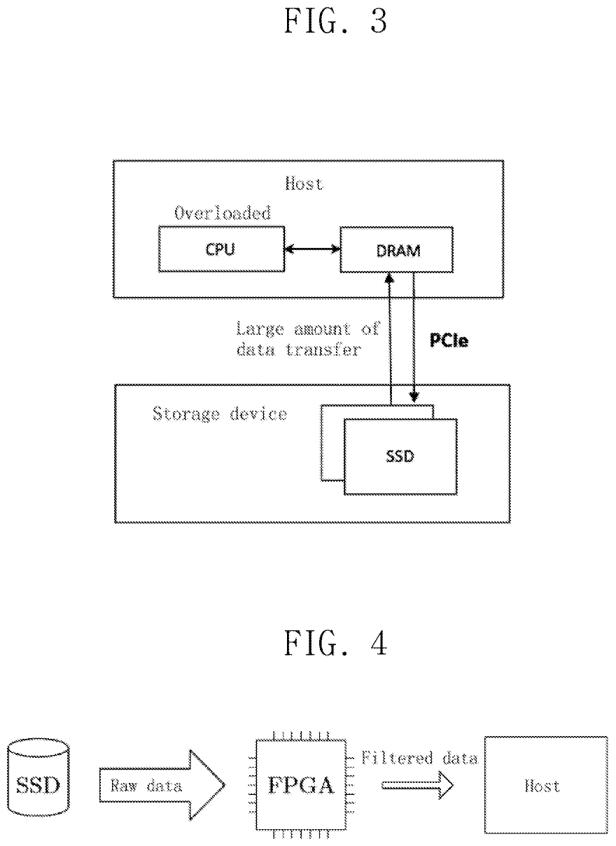

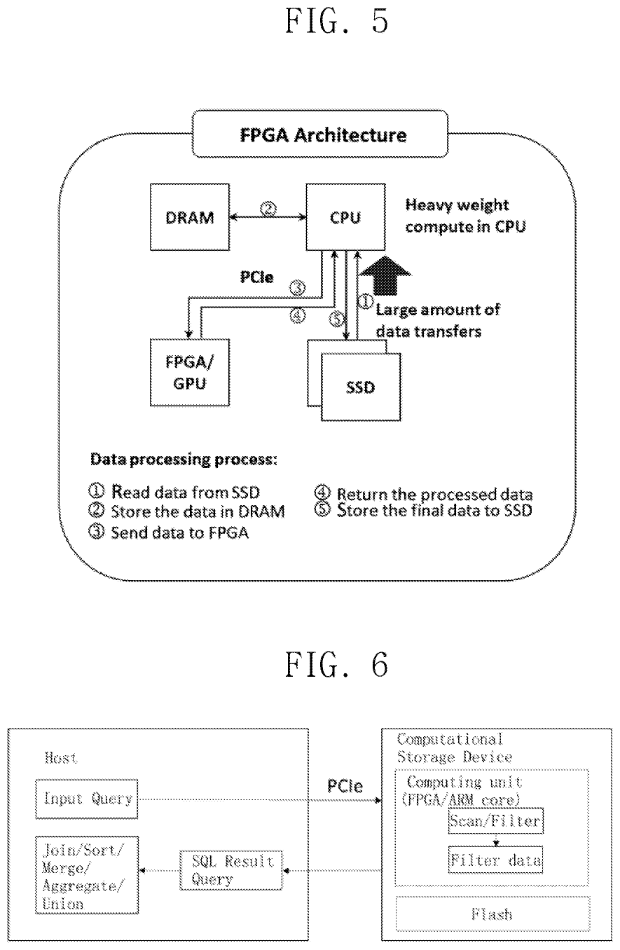

FIG. 1 is a flowchart illustrating a data processing method of a storage device according to an embodiment of the disclosure. FIG. 2 is a diagram illustrating an example of a typical query sequence. FIG. 3 is a diagram illustrating a related art example of performing a query operation between a host and a storage device. FIGS. 4 and 5 are diagrams illustrating an example of using an FPGA to offload a scanning and/or a filtering operation according to a first data processing method of the related art. Hereinafter, the scanning and/or the filtering operation may be referred to as “scan-filter” operation. However, the disclosure is not limited to a single scan-filter operation. As such, according to various embodiment, a query request may include a plurality of scan filter operations. FIG. 6 is a diagram illustrating an example of using a computational storage which offloads a database scan-filter scheme according to a second data processing method of the related art.

Referring to FIG. 1, in operation S100, a query request involving a scan-filter task is received from the host. According to an embodiment, the scan-filter task request may be a request to perform a scan-filter operation. For example, the scan-filter operation may include one or more operations for performing the scan-filter task.

According to an embodiment, the query request may be a Structured Query Language (SQL) query request. The SQL query request, hereinafter, may also be referred to as a SQL query plan. The SQL query plan may include basic building blocks (hereinafter, referred to as building blocks), which form an execution tree. A building block may be typically focused on a specific operation and may be scheduled by an SQL engine. The manner in which the building blocks are assembled may determine query performance. According to an embodiment, the building blocks may include scan, filtering, item, aggregating, sorting, joining, merging, union, etc. These building blocks may be referred to as major building blocks. FIG. 2 illustrates a typical query sequence, executing the building blocks from top to bottom. As shown in FIG. 3, in a related art system, the computations involved in a query request are executed in a processor of a host. The processor may be a central processing unit (CPU). For example, during data query processing, first, data is read from a storage device (e.g., a solid-state drive (SSD) in the storage device) into a memory (e.g., dynamic random-access memory (DRAM)) of the host, then the data is computed in the processor of the host, and finally, the computed data is returned to the storage device (e.g., the SSD in the storage device) after the computation is completed. Accordingly, this data query processing may generate a large amount of data movement and consume bandwidth resources. In addition, as the amount of data keeps increasing, the processor of the host can be overloaded and become a computational bottleneck in the data query processing. In order to address the problem of computational bottleneck, two different data processing methods are used in the related art. The first method of the related art is illustrated in FIGS. 4 and 5, and the second method of the related art is illustrated in FIG. 6.

In FIGS. 4 and 5, a first data processing method of the related art uses additional computing units to offload the scan-filter operations in SQL queries. For example, SQL queries involve complex processing tasks that includes query parsing, query plan generation/optimization, and actual data retrieval, and involve different multiple components to the database management system. Most of these processing tasks require general-purpose central processors for flexible processing, but operations such as scan, filtering, aggregating and so on can be performed by using additional computing units (e.g., field-programmable gate arrays (FPGAs)) to effectively increase throughput rates.

FPGAs can be used to improve performance while reducing power consumption in order to accelerate data-intensive applications. Since FPGAs can be built with custom hardware at a relatively low development cost, the resources utilized with FPGAs can be used to construct accelerators for accelerating different database systems. FPGA-based acceleration optimization solutions can be used to perform various data processing tasks. For example, FPGAs may be used to implement hardware accelerators close to the storage media in a data path of a database management system to support offloading of complex query operators. However, the use of additional computing units to offload scan-filter operations in SQL queries has the following drawbacks:

For example, even with the user of FPGA to offload scan-filter operation, there is still a large amount of data movement, resulting in bandwidth bottlenecks and data transfer delays. Particularly, during data processing using FPGA to offload scan-filter operation, first, the data is needed to be read from the storage device into the memory, then the data is transferred to the FPGA and processed in the FPGA, and finally, the processed data is returned to the processor of the host. This data processing may generate many data movement operations. In view of the increasing amount of data in the database recently, the large amount of data transfer will soon lead to new bottlenecks due to the bandwidth limitations of the host input-output (IO) interface, and the expansion of the data link also increases the data transfer delays.

Moreover, FPGAs occupy host memory resources and cannot be scaled linearly. FPGA cards come with a computing engine which can reduce the processor loads of the host and are suitable in many scenarios. However, FPGA cards will occupy one peripheral component interconnect express (PCIe) slot, and data read and write transfers will occupy memory resources, and the data link becomes longer. In addition, also limited by the FPGA card's arithmetic power and bandwidth, FPGAs cannot be linearly scaled.

Furthermore, FPGAs will become a new computing hotspot and will not be able to take full advantage of the high-speed bandwidth of SSDs. In particular, FPGAs will become a new computing hotspot as computing functions are offloaded, resulting in a new computing bottleneck. A large amount of data is transferred through the bandwidth between the host IO interface and the storage device, while the bandwidth inside the SSD is very large and underutilized.

As shown in FIG. 6, a second data processing method of the related art uses a computational storage offloading a database scan-filter scheme. In related art computer system designs, data is stored in a storage device and the data is read from the storage device to the processors of the host and processed, and then the results are written back to the storage device. As data amounts increase dramatically, this constant data movement leads to data movement walls, which prevent further processing and optimization in the design of data processing systems. A promising alternative to this architecture is to push computation into the data, and as a result, computational storage devices (CSDs) and CSD application frameworks have been designed.

Various research is being conducted to use In-storage Computing (ISC) for data processing as illustrated in FIG. 6. For example, complex query operations are offloaded to the SSD using ISC technology, which uses ISC to process and filter data. Thereafter, the filtered data is sent to the host side, which can reduce the movement of data.

However, related art computational storage schemes do not consider the computing capability of near-storage side devices and may cause computing blocking. Particularly, the near-storage computing scheme puts all the scan-filter tasks to the near-storage side for computing. However, the related art storage devices have weak computing capability, and the database performs a large proportion of scan-filter tasks in the computing process. When the computing capability of the storage device is insufficient, many execution statements will be in a waiting phase, which will degrade the performance of the data system.

As such, according to an embodiment of the disclosure as illustrated in FIG. 1, the storage device may be a storage with an ISC capability, and the storage device may receive a query request involving a scan-filter task from the host. Hereinafter, a storage with an ISC capability may be referred to as to as the storage device.

Referring to FIG. 1, in operation S200, the method may include determining whether a computing resource within the storage device is saturated with respect to the scan-filter operations.

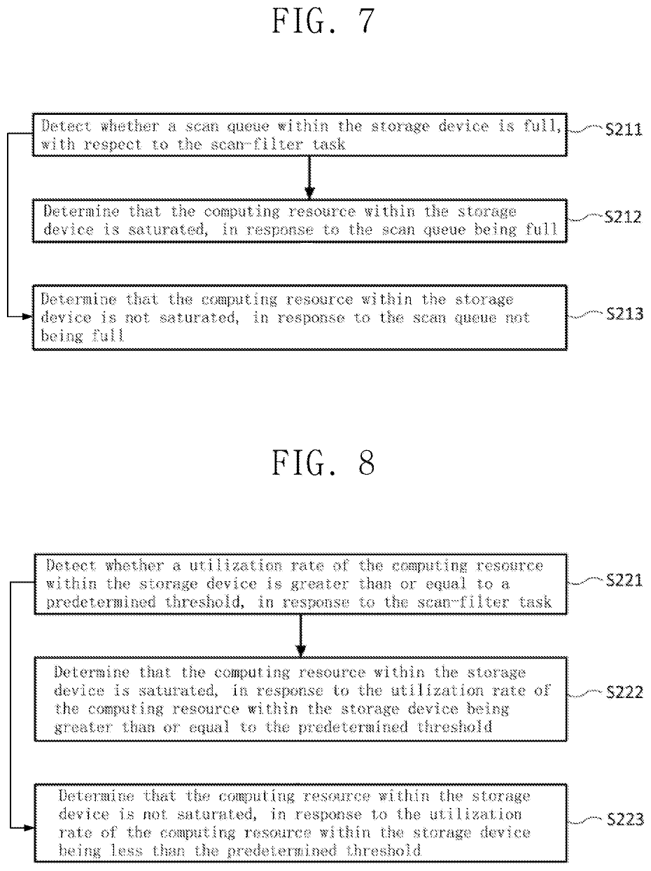

According to an embodiment, the storage device may determine whether the computing resource within the storage device is saturated based on a criteria. For example, according to an embodiments of the disclosure, after receiving a query command, instead of directly performing a scan-filter task to offload the scan-filter operations in the SQL query regardless of the computing resource of the storage device, the storage device first determines whether the computing resource within the storage device is saturated. That is, the storage device may selectively offload the scan-filter operations in the SQL query by selectively performing a scan-filter task based on whether the computing resource within the storage device is saturated. Thus, the storage device efficiently utilizes the computing resource. In the following, operation S200 will be described in detail with reference to FIGS. 7 and 8.

In operation S300, the method may include determining whether the storage device is needed to perform a scan-filter operation based on determining that the computing resource within the storage device is not saturated. For example, the method may include determining whether the storage device is needed to perform a scan-filter operation in response to determining that the computing resource within the storage device is not saturated.

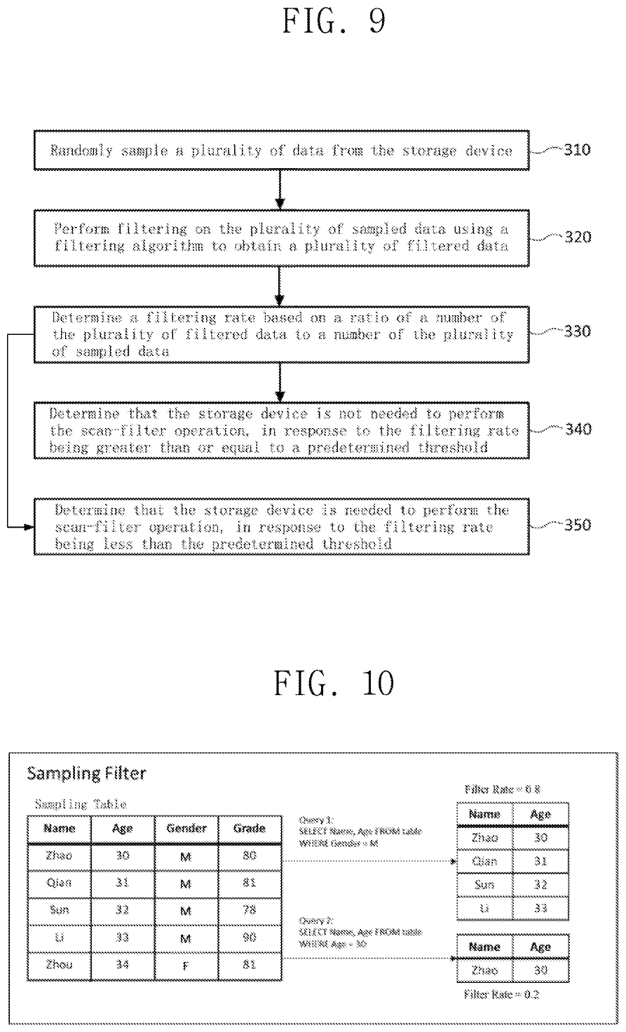

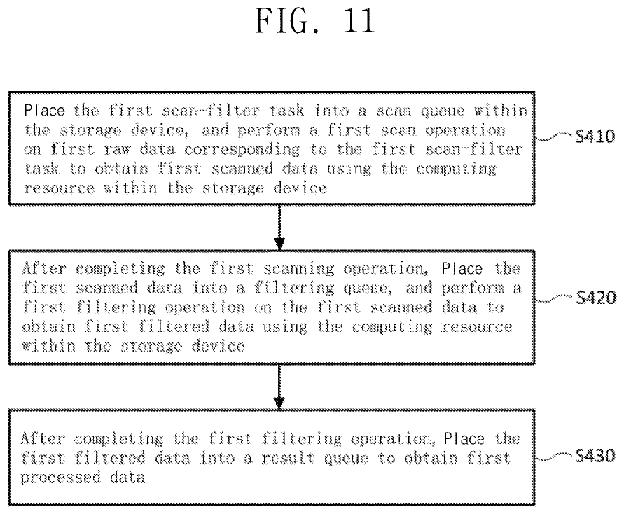

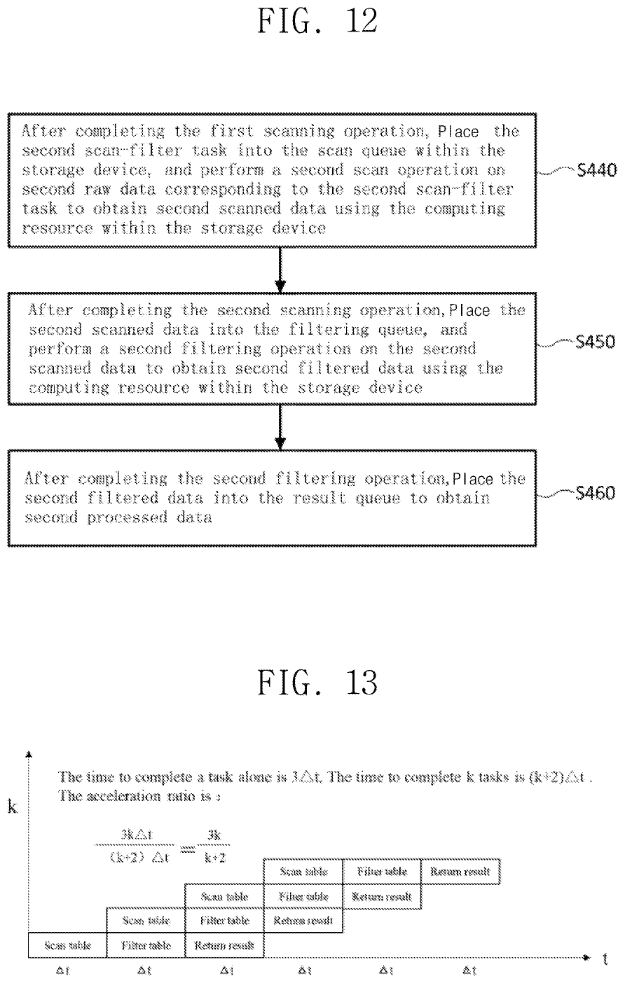

According to an embodiment, the storage device may determine whether the storage device is needed to perform a scan-filter operation, in response to determining that the computing resource within the storage device is not saturated. Further, According to an embodiment, the storage device may transmit the raw data within the storage device to the host, in response to determining that the computing resource within the storage device is saturated. That is, according to an embodiment of the disclosure, after receiving a query command, the storage device may first determine whether the storage device has sufficient computing resource to perform the scan query tasks and transmit the raw data to the host if the storage device does not have sufficient computing resource. Here, the storage device may transmit the raw data to the host if the storage device does not have sufficient computing resource to avoid degrading the performance of the data system due to many execution statements being in a waiting phase in the storage device. Operation S300 will be described in detail with reference to FIGS. 9 and 10.

In operation S400, the method may include performing the scan-filter operation on raw data within the storage device to obtain processed data, based on determining that the storage device is needed to perform the scan-filter operation.

According to an embodiment, the storage device may perform a scan-filter operation on the raw data within the storage device in response to determining that the storage device is needed to perform the scan-filter operation. In addition, According to an embodiment, the storage device may, in response to determining that the storage device is not needed to perform the scan-filter operation, transmit the raw data within the storage device to the host. That is, according to an embodiment of the disclosure, the storage device may, after receiving the query command, determine whether the storage device has sufficient computing resource to perform the scan query tasks, determine whether the storage device is needed to perform the scan-filter operation if it has sufficient computing resource, and perform the scan-filter process on the raw data only when both the above conditions are satisfied. Thus, according to an embodiment, the storage device may efficiently utilize the limited computing resource of the storage device by performing the method illustrated in in FIG. 1 Operation S400 will be described in detail with reference to FIGS. 11 to 13.

In operation S400, the processed data is transmitted to the host.

In the above described operations of FIG. 1, the processor of the host and the computing resource of the storage device can be realized to cooperate in processing the scan-filter task of the query request, so that the advantage of the strong scan-filter capability of the storage device is fully utilized and a large amount of data movement processing is reduced, while the processor of the host is used to perform the scan-filter when a computing bottleneck occurs in the storage device, preventing the query task from being in a long waiting phase. Thus, the limited computing resource of the processor of the host and the storage device can be efficiently utilized, and the computing bottleneck due to the overload of the processor of the host and the degradation of the performance of the data system due to many execution statements being in the waiting phase in the storage device are avoided.

FIG. 7 is a flowchart illustrating a method of determining whether a computing resource within a storage device is saturated according to an embodiment of the disclosure.

Referring to FIG. 7, in operation S211, the method may include determining whether a scan queue within the storage device is full with respect to the scan-filter task. For example, the storage device may detect whether a scan queue within the storage device is full. Here, the storage device may detect whether the scan queue within the storage device is full corresponding to the scan-filter task. In operation S212, the method may include determining that the computing resource within the storage device is saturated based on the scan queue being full. In operation S213, the method may include determining that the computing resource within the storage device is not saturated is determined based on the scan queue not being full. Thus, in the embodiment of FIG. 7, the storage device may determine whether the computing resource within the storage device is saturated by detecting the scan queue within the storage device.

FIG. 8 is a flowchart illustrating a method of determining whether a computing resource within a storage device is saturated according to an embodiment of the disclosure.

Referring to FIG. 8, in operation S221, the method includes determining whether a utilization rate of the computing resource within the storage device is greater than or equal to a threshold. For example, in operation S221, the storage device may detect whether the utilization rate of the computing resource within the storage device is greater than or equal to a reference threshold value in response to the scan-filter task. The reference threshold value may be a predetermined value. In operation S222, the method may include determining that the computing resource within the storage device is saturated based on the utilization rate of the computing resource within the storage device being greater than or equal to the predetermined threshold. In operation S223, the method may include determining that the computing resource within the storage device is not saturated based on the utilization rate of the computing resource within the storage device being less than the predetermined threshold. As such, according to an embodiment illustrated in FIG. 8, the storage device may determine whether the computing resource within the storage device is saturated by detecting the utilization rate of the computing resource within the storage device.

FIG. 9 is a flowchart illustrating a method of determining whether the storage device is needed to perform a scan-filter operation according to an embodiment of the disclosure. FIG. 10 is a diagram illustrating an example of a sample filtering operation according to an embodiment of the disclosure.

Referring to FIG. 9, in operation S310, the method includes randomly sampling a plurality of data from the storage device. Here, the randomly sampled data of from the storage device may be referred to as a plurality of sampled data. In operation S320, the method includes performing a filtering operation on the plurality of sampled data. For example, the storage device may perform the filtering operation on the plurality of sampled data using a filtering algorithm to obtain a plurality of filtered data. In operation S330, the method includes determining a filtering rate based on a ratio of a number of the plurality of filtered data to a number of the plurality of sampled data. In operation S340, the method includes determining that the storage device is not needed to perform the scan-filter operation based on the filtering rate being greater than or equal to a threshold. For example, the storage device may determine that the storage device is not needed to perform the scan-filter operation based on the filtering rate being greater than or equal to a reference threshold value. The reference threshold value may be a predetermined amount. The reference threshold value illustrated in FIG. 9 may be different from the reference threshold value illustrated in FIG. 8. In operation S350, the method includes determining that the storage device is needed to perform the scan-filter operation based on the filtering rate being less than the predetermined threshold.

According to an embodiment, the storage device may sample n pieces of data from a random sampling data table. The storage device may then perform filtering on the plurality of sampled data using a filtering algorithm to obtain m pieces of remaining data (i.e., filtered data). In this case, the filtering rate may be expressed as m/n. A larger value of m/n indicates a larger number of filtered remaining data, which indicates that the number of filtered remaining data does not differ significantly from the number of original data before filtering and that the query task requires low demand for filtering. On the other hand, a smaller value of m/n indicates a smaller number of filtered remaining data, which indicates that the filtered remaining data greatly reduces the amount of data movement, and the demand for filtering is high for the query task. Therefore, combined with FIG. 1, for a task with a high filtering rate, the storage device may directly read the original data back to the host, while for a task with a small filtering rate, the storage device may add the task to the scan queue for the next operation.

FIG. 10 illustrates an example of the sampling and filtering operation of FIG. 9. For example, the storage device may randomly sample 5 pieces of data from a data table as a sampling table. For Query 1, the storage device may filter and list the name information and age information for the data with a gender of male from the sampled table, thereby computing a filtering rate of 0.8 for Query 1, and may determine that Query 1 requires a low demand for filtering. In addition, for Query 2, the storage device may filter and list the name information and age information of the data with age 30 from the sampling table, thereby computing a filtering rate of 0.2 for Query 2, and may determine that Query 2 requires a high demand for filtering. In addition, although FIG. 10 uses the same sampling table for different queries, the disclosure is not limited thereto. For example, a different plurality of randomly sampled data from the data table may be used as different sampling tables for each query separately.

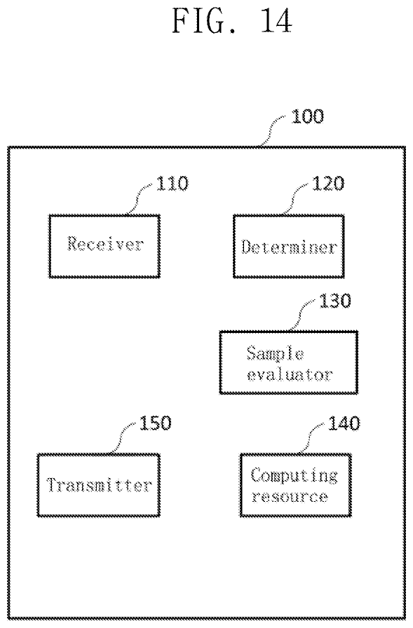

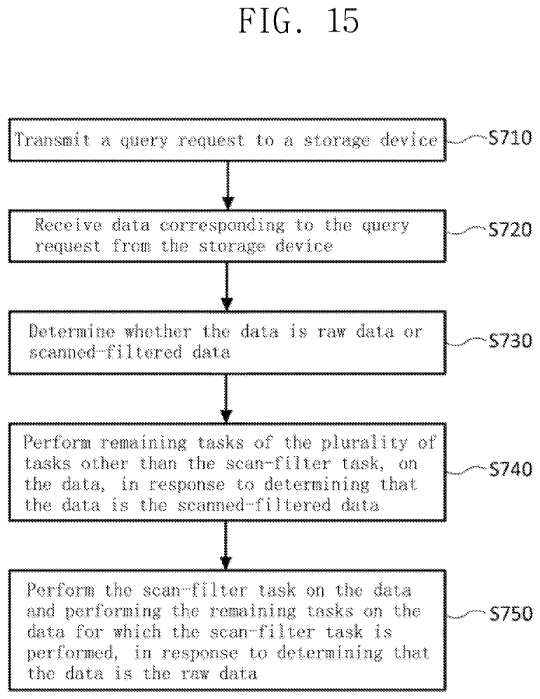

FIG. 11 is a flowchart illustrating a method of performing a scan-filter operation on raw data within a storage device according to an embodiment of the disclosure. FIG. 12 is a flowchart illustrating a method of performing a scan-filter operation on raw data within a storage device according to an embodiment of the disclosure. FIG. 13 is a diagram illustrating an example of using a pipeline approach to accelerate computation according to an embodiment of the disclosure.

Referring to FIG. 11, in operation S410, the method includes placing the first scan-filter task into a scan queue within the storage device, and performing a first scan operation on first raw data corresponding to the first scan-filter task to obtain first scanned data using the computing resource within the storage device. In operation S420, after the first scanning operation is completed, the method includes placing the first scanned data into a filtering queue, and performing a first filtering operation on the first scanned data to obtain first filtered data using the computing resource within the storage device. In operation S430, after the first filtering operation is completed, the method includes placing the first filtered data into a result queue to obtain first processed data.

According to an embodiment of the disclosure, the storage device may divide the scan-filter task into a scanning task, a filtering task, and a return task. According to an embodiment, the scanning task may be used to perform a scanning operation on the data, the filtering task may be used to perform a filtering operation on the scanned data, and the return task may be used to perform a return operation on the filtered data. Accordingly, the storage device may include a scan queue, a filter queue, and a return queue for processing the scan task, the filter task, and the return task, respectively. The scan task may be placed into the scan queue for performing the scan operation, the scanned data may be placed into the filter queue for performing the filter operation, and the filtered data may be placed into the return queue for performing the return operation. For example, According to an embodiment, the storage device may transmit the first processed data from the result queue to the host. Because the storage device includes the scan queue, the filter queue, and the return queue, a computing resource of the storage device may be pipelined to perform the scan-filter operation on the query task, thereby allowing for accelerating computing.

According to an embodiment of the disclosure, referring to FIG. 12, in operation S440, after the first scanning operation is completed, the method includes placing the second scan-filter task into the scan queue within the storage device, and performing a second scan operation on second raw data corresponding to the second scan-filter task to obtain second scanned data using the computing resource within the storage device. In operation S450, after the second scanning operation is completed, the method includes placing the second scanned data into the filtering queue, and performing a second filtering operation on the second scanned data to obtain second filtered data using the computing resource within the storage device. In operation S460, after the second filtering operation is completed, the method includes placing the second filtered data into the result queue to obtain first processed data.

Referring to FIG. 13, the computation for each query request is accelerated in a pipelined manner. For example, the computing resource of the storage device may perform a scan operation for the first query request. The computing resource of the storage device may simultaneously perform a filter operation for the first query request and a scan operation for the second query request. For example, the computing resource of the storage device may simultaneously perform a return operation for the first query request, a filter operation for the second query request, and a scan operation for the third query request. For example, the computing resource of the storage device may simultaneously perform a return operation for the second query request, a filter operation for the third query request, and a scan operation for the fourth query request. For example, the computing resource of the storage device may simultaneously perform a return operation for the third query request and a filter operation for the fourth query request. For example, the computing resource of the storage device may perform a return operation for the fourth query request. Assuming that the time to perform each operation by the computing resource of the storage device is Δt, and assuming that the number of query requests is k, the time to complete the scan query task involved in one query request is 3Δt, and the time to complete the scan query task involved in k query requests is (k+2) Δt, with an acceleration rate of:

$$\frac{3 k Δ t}{( k + 2 ) Δ t} = \frac{3 k}{k + 2}$$

As a result, the computation for each query request can be accelerated.

FIG. 14 is a block diagram illustrating a storage device according to an embodiment of the disclosure.

Referring to FIG. 14, the storage device 100 includes a receiver 110, a determiner 120, a sample evaluator 130, a computing resource 140, and a transmitter 150. According to an embodiment, one or more components of the storage device 100, including, but not limited to, the receiver 110, the determiner 120, the sample evaluator 130, the computing resource 140, and the transmitter 150 may be implemented by analog and/or digital circuits including one or more of a logic gate, an integrated circuit, a microprocessor, a microcontroller, a memory circuit, a passive electronic component, an active electronic component, an optical component, and the like. According to an embodiment, one or more components of the storage device may be implemented be driven by software. For example, the storage device 100 may include a memory may storing one or more instructions or program codes, and a processor configured to execute the one or more instructions or program codes to implement one or more components of the storage device 100, including, but not limited to, the receiver 110, the determiner 120, the sample evaluator 130, the computing resource 140, and the transmitter 150.

The storage device 100 may be a storage device with ISC capability.

The receiver 110 may be configured to receive a query request involving a scan-filter task from a host. According to an embodiment, the query request may be an SQL query request.

The determiner 120 may be configured to determine, with respect to the scan-filter task, whether the computing resource within the storage device is saturated.

According to an embodiment, the determiner 120 may determine whether the computing resource within the storage device is saturated according to predetermined criteria. That is, according to an embodiment of the disclosure, after receiving a query command, instead of directly performing a scan-filter task to offload the scan-filter operations in the SQL query regardless of the computational resources of the storage device, the storage device 100 first determines whether the computational resources within the storage device 100 are saturated by the determiner 120, to selectively offload the scan-filter operations in the SQL query by selectively performing the scan-filter task, thereby efficiently utilizing the computing resource.

For example, According to an embodiment, the determiner 120 may be configured to: detect whether a scan queue within the storage device is full, with respect to the scan-filter task; determine that the computing resource within the storage device is saturated, based on the scan queue being full; and determine that the computing resource within the storage device is not saturated, based on the scan queue not being full. Thus, in this example, the determiner 120 may determine whether the computing resource within the storage device is saturated by detecting the scan queue within the storage device.

For example, in another example, the determiner 120 may be configured to: detect whether a utilization rate of the computing resource within the storage device is greater than or equal to a predetermined threshold, based on the scan-filter task; determine that the computing resource within the storage device is saturated, based on the utilization rate of the computing resource within the storage device being greater than or equal to the predetermined threshold; determine that the computing resource within the storage device is not saturated, based on the utilization rate of the computing resource within the storage device being less than the predetermined threshold. Thus, in this example, the determiner 120 may determine whether the computing resource within the storage device is saturated by detecting the utilization rate of the computing resource within the storage device.

The sample evaluator may be configured to determine whether the storage device is needed to perform a scan-filter operation, based on determining that the computing resource within the storage device is not saturated.

According to an embodiment, the sample evaluator 130 may determine whether the storage device is needed to perform a scan-filter operation, based on determining that the computing resource within the storage device is not saturated. In addition, According to an embodiment, storage device 100 may transmit the raw data within the storage device to a host, based on determining that the computing resource within the storage device is saturated. That is, according to an embodiment of the disclosure, after receiving a query command, the sample evaluator 130 may first determine whether the storage device has a sufficient computing resource to perform the scan query tasks and directly transmit the raw data to the host if it does not have the sufficient computing resource, so as to avoid degrading the performance of the data system due to a large number of execution statements being in a waiting phase in the storage device.

Particularly, the sample evaluator 130 may be configured to: randomly sample a plurality of sampled data from the storage device; perform filtering on the plurality of sampled data using a filtering algorithm to obtain a plurality of filtered data; determine a filtering rate based on a ratio of a number of the plurality of filtered data to a number of the plurality of sampled data; determine that the storage device is not needed to perform the scan-filter operation, based on the filtering rate being greater than or equal to a predetermined threshold; and determine that the storage device is needed to perform the scan-filter operation, based on the filtering rate being less than the predetermined threshold.

For example, According to an embodiment, the sample evaluator 130 may sample n pieces of data from a randomly sampling data table. The sample evaluator 130 may then perform a filtering on the plurality of sampled data using a filtering algorithm to obtain m remaining pieces of data (i.e., filtered data). In this case, the filtering rate may be expressed as m/n. A larger value of m/n indicates a larger number of filtered remaining data, which indicates that the number of filtered remaining data does not differ significantly from the number of original data before filtering and that the query task requires low demand for filtering: conversely, a smaller value of m/n indicates a smaller number of filtered remaining data, which indicates that the filtered remaining data greatly reduces the amount of data movement, and the query task requires a high demand for filtering. Therefore, in conjunction with FIG. 1, for tasks with a high filtering rate, the storage device 100 can directly read the original data back to the host, while for tasks with a low filtering rate, the storage device 100 adds the task to the scan queue for the next operation.

The computing resource 140 may be configured to: perform the scan-filter operation on raw data within the storage device to obtain processed data, based on determining that the storage device is needed to perform the scan-filter operation.

According to an embodiment, computing resource 140 may perform a scan-filter operation on the raw data within the storage device based on determining that the storage device is needed to perform the scan-filter operation. Further, According to an embodiment, storage device 100 may, based on determining that the storage device does is not needed to perform the scan-filter operation, transmit the raw data within the storage device to the host. That is, according to an embodiment of the disclosure, the storage device 100 may, after receiving the query command, first determine whether the storage device 100 itself has the sufficient computing resource to perform the scan query, further determine whether the storage device 100 is needed to perform the scan-filter operation if it has the sufficient computing resource, and perform the scan-filter process on the raw data only when both of the above conditions are satisfied. The scan-filter process is performed for the original data only when both of the above conditions are satisfied. Thus, by the above two conditions, the limited computing resource of the storage device 100 can be efficiently utilized.

According to an embodiment, assuming that the query request includes a first query request involving a first scan-filter task, the computing resource 140 may be configured to: place the first scan-filter task into a scan queue within the storage device, and perform a first scan operation on first raw data corresponding to the first scan-filter task to obtain first scanned data using the computing resource within the storage device; after completing the first scanning operation, put the first scanned data into a filtering queue, and perform a first filtering operation on the first scanned data to obtain first filtered data using the computing resource within the storage device; and after completing the first filtering operation, place the first filtered data into a result queue to obtain first processed data.

According to an embodiment of the disclosure, the computing resource 140 may divide the scan-filter task into a scan task, a filter task, and a return task, wherein the scan task may be used to perform a scan operation on the data, the filter task may be used to perform a filter operation on the scanned data, and the return task may be used to perform a return operation on the filtered data. Accordingly, the storage device 100 may include a scan queue, a filter queue, and a return queue for processing the scan task, the filter task, and the return task, respectively. The scan task may be placed into the scan queue for performing the scan operation, the scanned data may be placed into the filter queue for performing the filter operation, and the filtered data may be placed into the return queue for performing the return operation. For example, According to an embodiment, the storage device 100 may transmit the first processing data from the results queue to the host. Because storage device 100 includes the scan queue, the filter queue, and the return queue, a computing resource 140 of storage device 100 may be pipelined to perform one or more scan-filter operations on query tasks, thereby allowing for accelerating computing.

Assuming that the query request further includes a second query request involving a second scan-filter task, the computing resource 140 may be configured to: after completing the first scanning operation, place the second scan-filter task into the scan queue within the storage device, and perform a second scan operation on second raw data corresponding to the second scan-filter task to obtain second scanned data using the computing resource within the storage device; after completing the second scanning operation, place the second scanned data into the filtering queue, and perform a second filtering operation on the second scanned data to obtain second filtered data using the computing resource within the storage device; and after completing the first filtering operation, place the first filtered data into a result queue to obtain first processed data.

The transmitter 150 may be configured to transmit the processed data to the host.

For example, as described above, after putting the first filtered data into the result queue, the transmitter 150 may be configured to transmit the first processed data in the result queue to the host. Similarly, after putting the second filtered data into the results queue, the transmitter 150 may be configured to transmit the second processed data from the result queue to the host.

In addition, the transmitter 150 may be configured to transmit the raw data within the storage device to the host based on determining that the computing resource within the storage device is saturated. In addition, the transmitter may be configured to transmit the raw data within the storage device to the host based on determining that the storage device is not needed to perform the scan-filter operation.

Through the above processing, the processor of the host and the computing resource 140 of the storage device 100 can be realized to cooperate in processing the scan-filter task in the query request, so that the advantage of the strong scan-filter capability of the storage device 100 can be fully utilized to reduce a large amount of data movement processing, while the CPU is used to perform the scan-filter when there is a computing bottleneck in the storage device 100 to prevent long waiting times for the query task. Thus, the limited computing resource 140 of the CPU of the host and the storage device 100 can be efficiently utilized, and the computing bottleneck due to the overloading of the CPU of the host and the degradation of the performance of the data system due to a large number of execution statements being in the waiting phase in the storage device 100 are avoided.

FIG. 15 is a flowchart illustrating a data processing method of a host according to an embodiment of the disclosure.

Referring to FIG. 15, in operation S710, the method include transmitting a query request to a storage device. For example, the host may transmit a query request to a storage device. The query request may include a plurality of tasks, the plurality of tasks includes a scan-filter task. According to an embodiment, the query request may be in a format compatibility with a format of the storage device. For example, the transmitting of a query request to a storage device may include converting a format of the query request to a format that the storage device can recognize and transmitting a format-converted query request to the storage device.

In operation S720, the method includes receiving data corresponding to the query request from the storage device.

In operation S730, the method includes determining whether the data is raw data or scanned-filtered data. According to an embodiment, whether the data is the raw data or the scanned-filtered data is determined according to an identification bit of the data.

In operation S740, the method includes performing remaining tasks of the plurality of tasks other than the scan-filter task, on the data, based on determining that the data is the scanned and filtered data. In operation S750, the method includes performing the scan-filter task on the data and performing the remaining tasks on the data for which the scan-filter task is performed based on determining that the data is the raw data.

Through the above operations, the processor of the host and the computing resource of the storage device can be realized to cooperate in processing the scan-filter task in the query request, so that the advantage of the strong scan-filter capability of the storage device can be fully utilized and a large amount of data movement processing can be reduced, while the processor of the host can be used to perform the scan-filter when a computing bottleneck occurs in the storage device to prevent the query task from being in a long waiting phase. Thus, the limited computing resource of the processor of the host and the storage device can be efficiently utilized, and the computing bottleneck due to the overload of the processor of the host and the degradation of the performance of the data system due to the large number of execution statements in the storage device in the waiting phase are avoided.

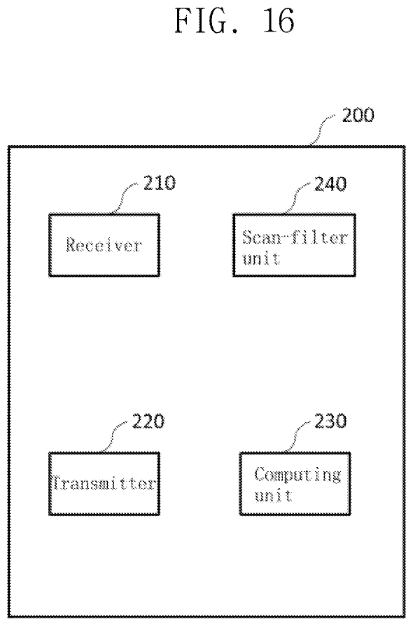

FIG. 16 is a block diagram illustrating a host according to an embodiment of the disclosure.

Referring to FIG. 16, a host 200 includes a transmitter 210, a receiver 220, a computing unit 230, and a scan-filter unit 240. According to an embodiment, one or more components of the host 200, including, but not limited to, the transmitter 210, the receiver 220, the computing unit 230, and the scan-filter unit 240 may be implemented by analog and/or digital circuits including one or more of a logic gate, an integrated circuit, a microprocessor, a microcontroller, a memory circuit, a passive electronic component, an active electronic component, an optical component, and the like. According to an embodiment, one or more components of the storage device may be implemented be driven by software. For example, the storage device 100 may include a memory may storing one or more instructions or program codes, and a processor configured to execute the one or more instructions or program codes to implement one or more components of the host 200, including, but not limited to, the transmitter 210, the receiver 220, the computing unit 230, and the scan-filter unit 240.

The transmitter 210 is configured to transmit the query request to the storage device, the query request includes a plurality of tasks, and the plurality of tasks includes a scan-filter task. According to an embodiment, the transmitter 210 may be configured to: convert a format of the query request to a format that the storage device can recognize; and transmit a converted format of the query request to the storage device.

The receiver 220 is configured to: receive data corresponding to a query request from the storage device, determine whether the data is raw data or scanned-filtered data, transmit the data to the scan-filtering unit based on determining that the data is the raw data, and transmit the data to the computing unit based on determining that the data is the scanned-filtered data. According to an embodiment, the receiver may be configured to determine whether the data is the raw data or the scanned-filtered data according to the identification bits of the data.

The computing unit 230 is configured to: perform the remaining tasks of the plurality of tasks, other than the scan-filter task, on the data. The scan-filter unit 240 is configured to: perform the scan-filter task on the data and transmit the data on which the scan-filter task has been performed to the computing unit to perform the remaining tasks on the data on which the scan-filter task has been performed. In addition, According to an embodiment, the computing unit 230 and the scan-filter unit 240 may be implemented by a central processor.

Through the above processing, the processor of the host 200 and the computing resource 140 of the storage device 100 can be realized to cooperate in processing the scan-filter task in the query request, so that the advantage of the strong scan-filter capability of the storage device 100 can be fully utilized to reduce a large amount of data movement processing, while the processor of the host is used to perform the scan-filter when the computing bottleneck occurs in the storage device 100 to prevent the query task appearing to wait for long periods of time. Thus, the limited computing resource 140 of the processor of the host computer 200 and the storage device 100 can be efficiently utilized and the computing bottleneck due to the overload of the CPU of the host computer 200 and the degradation of the performance of the data system due to a large number of executed statements being in the waiting phase in the storage device 100 are avoided.

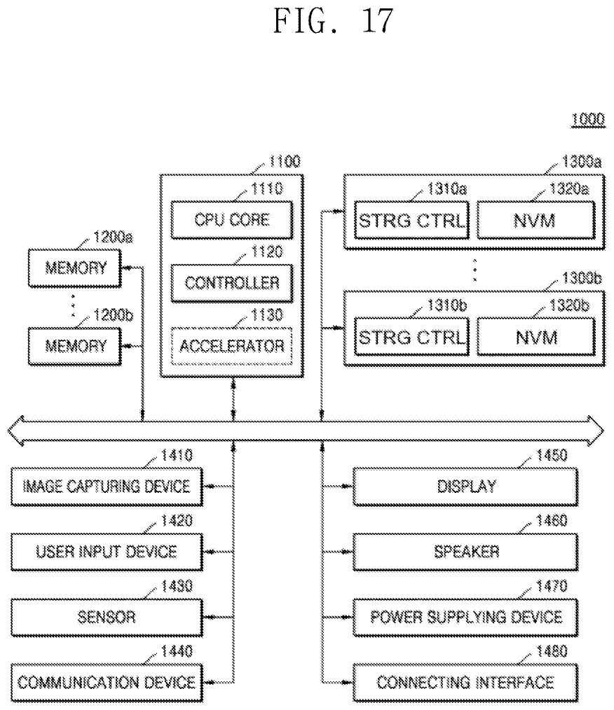

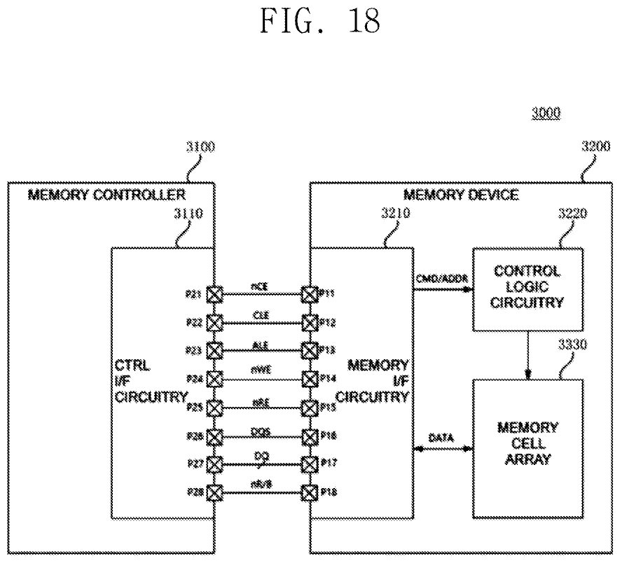

FIG. 17 is a schematic diagram of a system 1000 to which a storage device is applied according to an embodiment. The system 1000 of FIG. 17 may basically be a mobile system, such as a portable communication terminal (e.g., a mobile phone), a smartphone, a tablet personal computer (PC), a wearable device, a healthcare device, or an Internet of things (IoT) device. However, the system 1000 of FIG. 17 is not necessarily limited to the mobile system and may be a PC, a laptop computer, a server, a media player, or an automotive device (e.g., a navigation device).

Referring to FIG. 17, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

In some embodiments, the memory (e.g., 1200a and 1200b) and the storage devices (e.g., 1300a and 1300b) may correspond to the storage device 100 of FIG. 14 or to the memory and storage devices in the host computer 200 of FIG. 16, and the host processor 1100 may correspond to the computing resource in the storage device 100 of FIG. 14 or to the processor in the host computer 200 of FIG. 16 in FIG. 16. For example, the memory (e.g., 1200a and 1200b) and the storage devices (e.g., 1300a and 1300b) may store a computer program, the computer program, when executed by the main processor 1100, implements a method as described in at least one of FIGS. 1, 7-9, 11-13, or a method as described in FIG. 15, to access and control the memory (e.g., 1200a and 1200b) and memory devices (e.g., 1300a and 1300b)

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVMs (Non-Volatile Memories) 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

FIG. 18 is a block diagram of a storage system according to an embodiment of the disclosure. Referring to FIG. 18, the storage system 3000 may include a storage device 3200 and a memory controller 3100. The storage device 3200 may correspond to one of the NVM devices NVM11 to NVMmn, which communicates with the memory controller 9100 based on one of the plurality of channels CH1 to CHm of FIG. 19. The memory controller 3100 may correspond to the memory controller 9100 of FIG. 19.

In some embodiments, the storage device 3200 may correspond to the storage device 100 described in FIG. 14, and the memory controller 3100 may perform operations with reference to the method described in at least one of FIGS. 1, 7-9, and 11-13. For example, the memory controller 3100 may be configured to access and control the storage device 3200 with reference to the method described in at least one of FIGS. 1, 7-9, and 11-13.

The storage device 3200 may include first to eighth pins P11 to P18, a memory interface circuit 3210, a control logic circuit 3220, and a storage unit array 3330.

The memory interface circuit 3210 may receive the chip enable signal nCE from the memory controller 3100 through the first pin P11. The memory interface circuit 3210 may send and receive signals to and from the memory controller 3100 through the second to eighth pins P12 to P18 in response to the chip enable signal nCE. For example, when the chip enable signal nCE is in the enable state (E.G., low level), the memory interface circuit 3210 may send a signal to and receive a signal from the memory controller 3100 through the second to eighth pins P12 to P18.

The memory interface circuit 3210 may receive a command latch enable signal CLE, an address latch enable signal ALE, and a write enable signal nWE from the memory controller 3100 through the second to fourth pins P12 to P14. The memory interface circuit 3210 may receive the data signal DQ from the memory controller 3100 through the seventh pin P17 or send the data signal DQ to the memory controller 3100. Command CMD, address ADDR and data can be transmitted via data signal DQ. For example, the data signal DQ may be transmitted through a plurality of data signal lines. In this case, the seventh pin P17 may include a plurality of pins corresponding to a plurality of data signals DQ, respectively.

The memory interface circuit 3210 may obtain the command CMD from the data signal DQ received in the enable interval (E.G., high-level state) of the command latch enable signal CLE based on the switching time point of the write enable signal nWE. The memory interface circuit 3210 may obtain the address ADDR from the data signal DQ received in the enable interval (E.G., high-level state) of the address latch enable signal ALE based on the switching time point of the write enable signal nWE.

In an exemplary embodiment, the write enable signal nWE may remain static (E.G., high level or low level) and switch between high level and low level. For example, the write enable signal nWE can be switched in the interval where the command CMD or address ADDR is sent. Therefore, the memory interface circuit 3210 can obtain the command CMD or address ADDR based on the switching time point of the write enable signal nWE.

The memory interface circuit 3210 may receive the read enable signal nRE from the memory controller 3100 through the fifth pin P15. The memory interface circuit 3210 may receive the data strobe signal DQS from the memory controller 3100 through the sixth pin P16, or may send the data strobe signal DQS to the memory controller 3100.

In the data (DATA) output operation of the storage device 3200, the memory interface circuit 3210 may receive the read enable signal nRE switched by the fifth pin P15 before outputting the data DATA. The memory interface circuit 3210 may generate a data strobe signal DQS, which is switched based on the switching of the read enable signal nRE. For example, the memory interface circuit 3210 may generate a data strobe signal DQS based on the switching start time of the read enable signal nRE, which starts switching after a predetermined delay (E.G., tDQSRE). The memory interface circuit 3210 may transmit a data signal DQ including data DATA based on the switching time point of the data strobe signal DQS. Therefore, the data DATA can be aligned with the switching time point of the data strobe signal DQS and transmitted to the memory controller 3100.

In the data (DATA) input operation of the storage device 3200, when the data signal DQ including data DATA is received from the memory controller 3100, the memory interface circuit 3210 may receive the switched data strobe signal DQ and data DATA. The memory interface circuit 3210 may obtain data DATA from the data signal DQ based on the switching time point of the data strobe signal DQS. For example, the memory interface circuit 3210 may sample the data signal DQ at the rising and falling edges of the data strobe signal DQS and obtain data DATA.

The memory interface circuit 3210 can send the ready/busy output signal nR/B to the memory controller 3100 through the eighth pin P18. The memory interface circuit 3210 may transmit the status information of the storage device 3200 to the memory controller 3100 through the ready/busy output signal nR/B. When the storage device 3200 is in a busy state (i.e., when an operation is being performed in the storage device 3200), the memory interface circuit 3210 may send a ready/busy output signal nR/B indicating the busy state to the memory controller 3100. When the storage device 3200 is in the ready state (i.e., when no operation is performed or completed in the storage device 3200), the memory interface circuit 3210 may send the ready/busy output signal nR/B indicating the ready state to the memory controller 3100. For example, when the storage device 3200 reads data from the storage unit array 3330 in response to a page reading command, the memory interface circuit 3210 may send a ready/busy output signal nR/B indicating a busy state (E.G., low level) to the memory controller 3100. For example, when the storage device 3200 programs the data DATA to the storage unit array 3330 in response to the programming command, the memory interface circuit 3210 may send the ready/busy output signal nR/B indicating the busy state to the memory controller 3100.

The control logic 3220 may control all operations of the storage device 3200. The control logic circuit 3220 may receive a command/address CMD/ADDR obtained from the memory interface circuit 3210. The control logic 3220 may generate control signals for controlling other components of the storage device 3200 in response to the received command/address CMD/ADDR. For example, the control logic circuit 3220 may generate various control signals for programming data DATA to or reading data DATA from the storage unit array 3330.

The storage unit array 3330 may store the data DATA obtained from the memory interface circuit 3210 via the control of the control logic circuit 3220. The storage unit array 3330 may output the stored data DATA to the memory interface circuit 3210 via the control of the control logic circuit 3220.

The storage unit array 3330 may include a plurality of storage units. For example, a plurality of storage units may be flash memory units. However, the disclosure is not limited to this, and the storage unit may be an RRAM unit, a FRAM unit, a PRAM unit, a thyristor RAM (TRAM) unit or an MRAM unit. Hereinafter, an embodiment in which the storage unit is a NAND flash memory unit will be mainly described.

The memory controller 3100 may include first to eighth pins P21 to P28 and a controller interface circuit 3110. The first to eighth pins P21 to P28 may correspond to the first to eighth pins P11 to P18 of the storage device 3200, respectively.

The controller interface circuit 3110 may send the chip enable signal nCE to the storage device 3200 through the first pin P21. The controller interface circuit 3110 may send a signal to and receive a signal from the storage device 3200 through the second to eighth pins P22 to P28, wherein the storage device 3200 is selected by the chip enable signal nCE.

The controller interface circuit 3110 may send the command latch enable signal CLE, the address latch enable signal ALE and the write enable signal nWE to the storage device 3200 through the second to fourth pins P22 to P24. The controller interface circuit 3110 may send or receive the data signal DQ to or from the storage device 3200 through the seventh pin P27.

The controller interface circuit 3110 may transmit the data signal DQ including the command CMD or address ADDR and the switched write enable signal nWE to the storage device 3200. The controller interface circuit 3110 may transmit the data signal DQ including the command CMD to the storage device 3200 by transmitting the command latch enable signal CLE with the enable state. Moreover, the controller interface circuit 3110 may transmit the data signal DQ including the command CMD to the storage device 3200 through an address latch enable signal ALE having an enable state that is transmitted to transmit a data signal DQ including an address ADDR to the storage device 3200.

The controller interface circuit 3110 may send the read enable signal nRE to the storage device 3200 through the fifth pin P25. The controller interface circuit 3110 may receive the data strobe signal DQS from the storage device 3200 or send the data strobe communication signal DQS to the storage device 3200 through the sixth pin P26.

In the data (DATA) output operation of the storage device 3200, the controller interface circuit 3110 may generate a switched read enable signal nRE and send the read enable signal nRE to the storage device 3200. For example, before outputting the data DATA, the controller interface circuit 3110 may generate a read enable signal nRE from a static state (e.g., high level or low level) Therefore, the storage device 3200 can generate the switched data strobe signal DQS based on the read enable signal nRE. The controller interface circuit 3110 can receive the data signal DQ including data DATA and the switched data strobe signal DQS from the storage device 3200. The controller interface circuit 3110 can obtain data DATA from the data signal DQ based on the switching time point of the data strobe signal DQS.

During the data (DATA) input operation of the storage device 3200, the controller interface circuit 3110 may generate a switched data strobe signal DQS. For example, before transmitting the data DATA, the controller interface circuit 3110 may generate a data strobe signal DQS from a static state (E.G., high level or low level), which may transmit the data signal DQ including the data DATA to the storage device 3200 based on the switching time point of the data strobe signal DQS.

The controller interface circuit 3110 may receive the ready/busy output signal NR/B from the storage device 3200 through the eighth pin P28. The controller interface circuit 3110 may determine the status information of the storage device 3200 based on the ready/busy output signal nR/B.

FIG. 19 is a block diagram of a storage system 9000 according to an embodiment of the disclosure. Referring to FIG. 19, the storage system 9000 may include a storage device 9200 and a memory controller 9100. The storage system 9000 may support multiple channels CH1 to CHM, and the storage device 9200 may be connected to the memory controller 9100 through the multiple channels CH1 to CHM. For example, storage system 9000 may be implemented as a storage device such as an SSD.

In some embodiments, the storage device 9200 may correspond to the storage device 100 described in FIG. 14, and the memory controller 9100 may perform operations with reference to the method described in at least one of the FIGS. 1, 7-9, and 11-13. For example, the memory controller 9100 may be configured to access and control the storage device 9200 with reference to the method described in at least one of FIGS. 1, 7-9, and 11-13.

The storage device 9200 may include a plurality of NVM devices NVM11 to NVMmn. Each of the NVM devices NVM11 to NVMmn can be connected to one of the plurality of channels CH1 to CHM through its corresponding path. For example, NVM devices NVM11 to NVM1n may be connected to the first channel CH1 through paths W11 to W1n, and NVM devices NVM21 to NVM2n may be connected to the second channel CH2 through paths W21 to W2n. In an exemplary embodiment, each of the NVM devices NVM11 to NVM1n may be implemented as any storage element, which may operate according to a separate command from the memory controller 9100. For example, each of the NVM devices NVM11 to NVM1n may be implemented as a chip or die, but the disclosure is not limited thereto.

The memory controller 9100 may send and receive signals to and from the storage device 9200 through the plurality of channels CH1 to CHM. For example, the memory controller 9100 may send commands CMDa to CMDm, addresses ADDRa to ADDRm, and data DATAa to DATAm to the storage device 9200 through channels CH1 to CHm, or receive data DATA DATAa to DATAm from the storage device 9200.

The memory controller 9100 may select one from the NVM devices NVM11 to NVMmn connected to each of the channels CH1 to CHM by using the corresponding one of the channels CH1 to CHm, and send and receive signals to and from the selected NVM device. For example, the memory controller 9100 may select the NVM device NVM11 from the NVM devices NVM11 to NVM1n connected to the first channel CH1. The memory controller 9100 can send the command CMDA, address ADDRa and data DATA to the selected NVM device NVM11 through the first channel CH1, or receive data DATA from the selected NVM device NVM11.

The memory controller 9100 may send and receive signals to and from the storage device 9200 in parallel through channels different from each other. For example, the memory controller 9100 may send the command CMDa to the storage device 9200 through the first channel CH1 and the command CMDb to the storage device 9200 through the second channel CH2. For example, the memory controller 9100 may receive data DATAa from the storage device 9200 through the first channel CH1 and data DATAb from the storage device 9200 through the second channel CH2.

The memory controller 9100 may control all operations of the storage device 9200. The memory controller 9100 may send signals to channels CH1 to CHM and control each of the NVM devices NVM11 to NVMmn connected to channels CH1 to CHm. For example, the memory controller 9100 may send a command CMDa and an address ADDRa to the first channel CH1 and control one selected from the NVM devices NVM11 to NVM1n.

Each of the NVM devices NVM11 to NVMmn can be operated via the control of the memory controller 9100. For example, the NVM device NVM11 may program the data DATAa based on the command CMDa, the address ADDRa, and the data DATAa provided to the first channel CH1. For example, the NVM device NVM21 may read the data DATAb based on the command CMDB and the address ADDRb provided to the second channel CH2, and send the read data DATAb to the memory controller 9100.

Although FIG. 19 shows an example in which the storage device 9200 communicates with the memory controller 9100 through M channels and includes N NVM devices corresponding to each channel, the number of channels and the number of NVM devices connected to one channel can be changed.

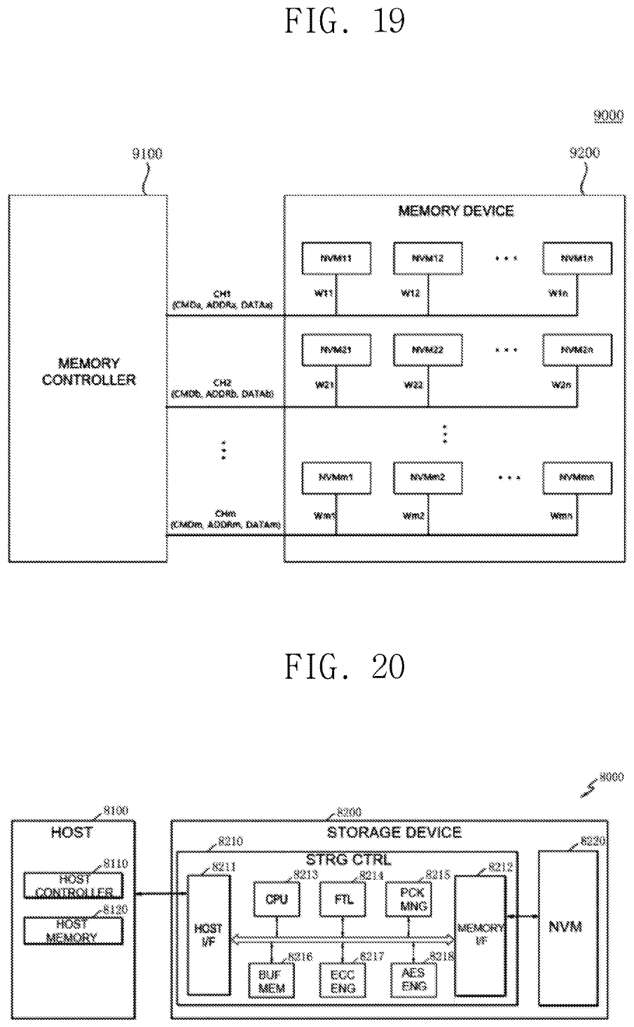

FIG. 20 is a block diagram of a host storage system 8000 according to an exemplary embodiment. Referring to FIG. 20, the host storage system 8000 may include a host 8100 and a storage device 8200. In addition, the storage device 8200 may include a memory controller 8210 and a NVM 8220. According to an exemplary embodiment of the disclosure, the host 8100 may include a host controller 8110 and a host memory 8120. The host memory 8120 may be used as a buffer memory configured to temporarily store data to be transmitted to or received from the storage device 8200.

In some embodiments, the host 8100 may correspond to the host 200 described in FIG. 16, and the storage device 8200 may correspond to the storage device 100 described in FIG. 14. For example, the host 8100 may be configured to access the storage device 8200 according to the method described in FIG. 15. The storage device 8200 may be configured to access host 8100 with reference to the method described in at least one of FIGS. 1, 7-9, and 11-13.

The storage device 8200 may include a storage medium configured to store data in response to a request from the host 8100. As an example, the storage device 8200 may include at least one of an SSD, an embedded memory, and a removable external memory. When the storage device 8200 is an SSD, the storage device 8200 may be an NVMe compliant device. When the storage device 8200 is an embedded memory or an external memory, the storage device 8200 may be a device conforming to the UFS standard or eMMC standard. Both the host 8100 and the storage device 8200 can generate a packet and send the packet according to the adopted standard protocol.

When the NVM 8220 of the storage device 8200 includes a flash memory, the flash memory may include a 2D NAND storage array or a 3D (or vertical) NAND (VNAND) storage array. As another example, the storage device 8200 may include various other kinds of NVMs. For example, the storage device 8200 may include magnetic random access memory (MRAM), spin transfer torque MRAM, conductive bridge RAM (CBRAM), ferroelectric RAM (FRAM), PRAM, RRAM, and various other types of memory.

According to an embodiment, the host controller 8110 and the host memory 8120 may be implemented as separate semiconductor chips. Alternatively, in some embodiments, the host controller 8110 and the host memory 8120 may be integrated in the same semiconductor chip. As an example, the host controller 8110 may be any one of a plurality of modules included in an application processor (AP). The AP can be implemented as a system on chip (SOC). In addition, the host memory 8120 may be an embedded memory included in the AP or a memory module external to the AP.

The host controller 8110 may manage an operation of storing data (e.g., write data) of the buffer area of the host memory 8120 in the NVM 8220 or an operation of storing data (E.G., read data) of the NVM 8220 in the buffer area.

The memory controller 8210 may include a host interface 8211, a memory interface 8212, and a CPU 8213. In addition, the memory controller 8210 may also include a flash conversion layer (FTL) 8124, a packet manager 8215, a buffer memory 8216, an error correction code (ECC) engine 8217, and an advanced encryption standard (AES) engine 8218. The memory controller 8210 may further include a working memory in which the FTL 8124 is loaded. The CPU 8213 may execute FTL 8124 to control data write and read operations on the NVM 8220.

The host interface 8211 may send and receive packets to and from the host 8100. The packet sent from the host 8100 to the host interface 8211 may include commands or data to be written to the NVM 8220. The packet sent from the host interface 8211 to the host 8100 may include a response to a command or data read from the NVM 8220. The memory interface 8212 may send data to be written to the NVM 8220 or receive data read from the NVM 8220. The memory interface 8212 may be configured to comply with standard protocols such as toggle or open NAND flash interface (ONFI).

FTL 8124 can perform various functions, such as an address mapping operation, wear balancing operation and garbage collection operation. The address mapping operation can be an operation of converting the logical address received from host 8100 into the physical address used to actually store data in NVM 8220. The wear balancing operation can prevent excessive degradation of specific blocks by allowing uniform use of NVM 8220 blocks Technology. As an example, the wear equalization or balancing operation can be realized by using firmware technology to balance the erase count of physical blocks. The garbage collection operation can be a technology to ensure the available capability in NVM 8220 by erasing the existing blocks after copying the valid data of the existing blocks to the new blocks.

The packet manager 8215 may generate packets according to a protocol that agrees to the interface of the host 8100, or parse various types of information from packets received from the host 8100. In addition, the buffer memory 8216 may temporarily store data to be written to or read from the NVM 8220. Although the buffer memory 8216 may be a component included in the memory controller 8210, it does not buffer storage, the memory controller 8216 may be external to the memory controller 8210.

ECC engine 8217 can perform error detection and correction operations on the read data read from NVM 8220. More specifically, ECC engine 8217 can generate parity bits for the write data to be written to NVM 8220, and the generated parity bits can be stored in NVM 8220 together with the write data. During reading data from NVM 8220, ECC engine 8217 can use read Data and the parity bit read from NVM 8220 to correct the error in the read data, and output the read data after error correction.

The AES engine 8218 may perform at least one of an encryption operation and a decryption operation on the data input to the memory controller 8210 by using a symmetric key algorithm.

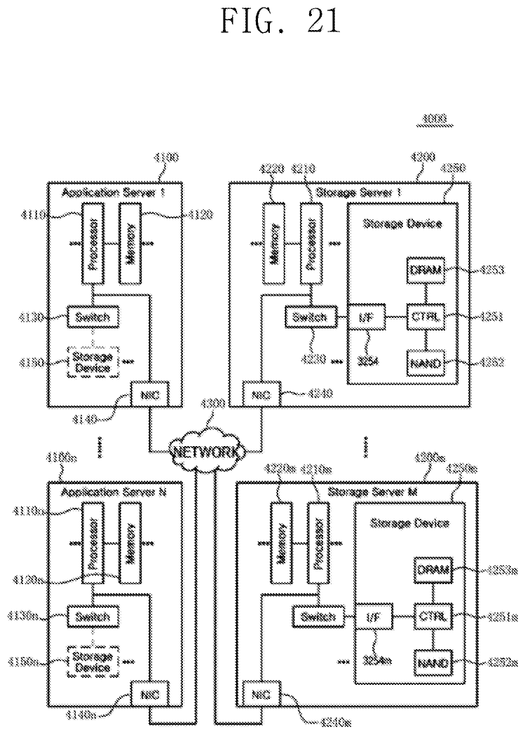

FIG. 21 is a block diagram of a data center 4000 to which a storage device is applied according to an embodiment of the disclosure.

Referring to FIG. 21, the data center 4000 may be a facility for collecting various types of data and providing services, and is referred to as a data storage center. The data center 4000 may be a system for operating search engines and databases, and may be a computing system used by companies (such as banks) or government agencies. The data center 4000 may include application servers 4100 to 4100n and storage servers 4200 to 4200m. According to an embodiment, the number of applications 4100 to 4100n and the number of storage servers 4200 to 4200m can be selected differently. The number of application servers 4100 to 4100n and the number of storage servers 4200 to 4200m may be different from each other.

In some embodiments, one or more of application servers 4100 to 4100n may correspond to host 200 described in FIG. 16, and one or more of storage servers 4200 to 4200m may correspond to storage devices 100 described in FIG. 14. For example, one or more of application servers 4100 to 4100n may be configured to access and control one or more of storage servers 4200 to 4200m according to the method described in FIG. 15, and one or more of storage servers 4200 to 4200m may be configured to access and control one or more of storage servers 4200 to 4200m according to the method described in at least one of FIGS. 1, 7-9, and 11-13.

The application server 4100 or the storage server 4200 may include processors 4110 and 4210 and at least one of memories 4120 and 4220. The storage server 4200 will now be described as an example. The processor 4210 may control all operations of the storage server 4200, access the memory 4220, and execute instructions and/or data loaded into the memory 4220. The memory 4220 may be a dual data rate synchronous DRAM (DDR SDRAM), a high bandwidth memory (HBM), a hybrid memory cube (HMC), a dual in-line memory module (DIMM), an Optane DIMM, or a nonvolatile DIMM (NVMDIMM). In some embodiments, the number of processors 4210 and memory 4220 included in the storage server 4200 may be selected differently. In one embodiment, processor 4210 and memory 4220 may provide a processor-memory pair. In another embodiment, the number of processors 4210 and the number of memories 4220 may be different from each other. The processor 4210 may include a single core processor or a multi-core processor. The above description of the storage server 4200 can be similarly applied to the application server 4100. In some embodiments, the application server 4100 may not include a storage device 4150. The storage server 4200 may include at least one storage device 4250. According to an embodiment, the number of storage devices 4250 included in the storage server 4200 may be selected differently.

Application servers 4100 to 4100n can communicate with storage servers 4200 to 4200m through network 4300. The network 4300 may be implemented by using fiber channel (FC) or Ethernet. In this case, FC can be a medium for relatively high-speed data transmission, and optical switches with high performance and high availability can be used. According to the access method of the network 4300, the storage servers 4200 to 4200m can be set as file storage, block storage or object storage.

In one embodiment, the network 4300 may be a network dedicated to storage, such as a storage area network (SAN). For example, a San can be a FC-SAN that uses an FC network and is implemented according to the FC protocol (FCP). As another example, the San may be an Internet Protocol (IP)-SAN, which uses a transmission control protocol (TCP)/IP network and is implemented according to SCSI over TCP/IP or Internet SCSI (iSCSI) protocol. In another embodiment, the network 4300 may be a general-purpose network, such as a TCP/IP network. For example, the network 4300 may be implemented according to protocols such as FC (FCOE) over Ethernet, network attached storage (NAS), and fabric nvme (NVMe-of).

Hereinafter, the application server 4100 and the storage server 4200 will be mainly described. The description of the application server 4100 may be applied to another application server 4100n, and the description of the storage server 4200 may be applied to another storage server 4200m.

The application server 4100 may store the data requested to be stored by the user or the client in one of the storage servers 4200 to 4200m through the network 4300. In addition, the application server 4100 can obtain data requested to be read by a user or a client from one of the storage servers 4200 to 4200m through the network 4300. For example, the application server 4100 may be implemented as a network server or a database management system (DBMS).

The application server 4100 may access the memory 4120n or the storage device 4150n included in another application server 4100n through the network 4300. Alternatively, the application server 4100 may access the memories 4220 to 4220m or storage devices 4250 to 4250m included in the storage servers 4200 to 4200m through the network 4300. Therefore, the application server 4100 may perform various operations on the data stored in the application servers 4100 to 4100n and/or the storage servers 4200 to 4200m. For example, the application server 4100 may execute instructions for moving or copying data between the application servers 4100 to 4100n and/or the storage servers 4200 to 4200m. In this case, data may be moved from the storage devices 4250 to 4250m of the storage servers 4200 to 4200m through the memories 4220 to 4220m of the storage servers 4200 to 4200m or directly to the memories 4120 to 4120n of the application servers 4100 to 4100n. The data moved through the network 4300 may be data encrypted for security or privacy.

The storage server 4200 will now be described as an example. The interface 4254 may provide a physical connection between the processor 4210 and the controller 4251 and a physical connection between the network interface card (NIC) 4240 and the controller 4251. For example, the interface 4254 may be implemented using a direct attached storage (DAS) scheme, where the storage device 4250 is directly connected to a dedicated cable. For example, interface 4254 can be implemented by using various interface schemes, such as ATA, SATA, E-SATA, SCSI, SAS, PCI, PCIe., nvme, IEEE 1394, USB interface, SD card interface, MMC interface, eMMC interface, UFS interface, eUFS interface and CF card interface.

The storage server 4200 may further include a switch 4230 and a network interconnect (NIC) 4240. The switch 4230 may selectively connect the processor 4210 to the storage device 4250 via the control of the processor 4210, or selectively connect the NIC 4240 to the storage device 4250.

In one embodiment, NIC 4240 may include a network interface card and a network adapter. NIC 4240 can be connected to network 4300 through wired interface, wireless interface, Bluetooth interface or optical interface. The NIC 4240 may include an internal memory, a digital signal processor (DSP), and a host bus interface, and is connected to the processor 4210 and/or the switch 4230 through the host bus interface. The host bus interface may be implemented as one of the above examples of interface 4254. In one embodiment, NIC 4240 may be integrated with at least one of processor 4210, switch 4230, and storage device 4250.

In storage servers 4200 to 4200m or application servers 4100 to 4100n, the processor may send commands to storage devices 4150 to 4150n and 4250 to 4250m or memories 4120 to 4120n and 4220 to 4220m and program or read data. In this case, the data can be the wrong data corrected by the ECC engine. The data may be data on which a data bus inversion (DBI) operation or a data masking (DM) operation is performed, and may include cyclic redundancy coding (CRC) information. Data can be encrypted for security or privacy.

The storage devices 4150 to 4150n and 4250 to 4250m may send control signals and command/address signals to the NAND flash memory devices 4252 to 4252m in response to a read command received from the processor. Therefore, when reading data from the NAND flash memory devices 4252 to 4252m, the read enable (RE) signal can be input as the data output control signal. Therefore, the data can be output to the DQ bus. The RE signal can be used to generate the data strobe signal DQS. Depending on the rising or falling edge of the write enable (WE) signal, the command and address signals can be locked in the page buffer.

The controller 4251 may control all operations of the storage device 4250. In one embodiment, the controller 4251 may include a SRAM. The controller 4251 may write data to the NAND flash memory device 4252 in response to a write command or read data from the NAND flash memory device 4252 in response to a read command. For example, write commands and/or read commands may be provided from processor 4210 of storage server 4200, processor 4210m of another storage server 4200m, or processors 4110 and 4110n of application servers 4100 and 4100n. The DRAM 3253 may temporarily store (or buffer) data to be written to or read from the NAND flash memory device 4252. Also, DRAM 3253 can store metadata. Here, the metadata may be user data or data generated by the controller 4251 for managing the NAND flash memory device 4252. The storage device 4250 may include a security element (SE) for security or privacy.

The method described in FIGS. 1, 7, 8, 9, 11, 12, 13 and 15 according to an embodiment of the disclosure may be written as a computer program and stored on a computer readable storage medium. When the computer program is executed by a processor, the method of the storage device as described above may be implemented. Examples of computer readable storage media include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid state drive (SSD), card memory (e.g. multimedia cards, Secure Digital (SD) cards or Extreme Digital (XD) cards), magnetic tapes, floppy disks, magneto-optical data storage devices, optical data storage devices, hard disks, solid state disks, and any other device configured to store computer programs and any associated data, data files, and data structures in a non-transitory manner and to provide the computer programs and any associated data, data files and data structures to a processor or computer such that the processor or computer can execute the computer program. According to an embodiment, the computer program and any associated data, data files, and data structures are distributed on a networked computer system such that the computer program and any associated data, data files, and data structures are stored, accessed, and executed in a distributed manner by one or more processors or computers

Therefore, the scheme of host-storage device co-processing scan-filter based on sampling and filtering proposed by the disclosure can effectively reduce the workload of the processor of the host, increase the efficiency of database query, improve database performance, and near data processing and intelligent/computing storage devices can reduce unnecessary data movement and accelerate data processing speed.

While the disclosure has been specifically shown and described with reference to its exemplary embodiments, it should be understood by those skilled in the art that various changes in form and detail may be made thereto without departing from the spirit and scope of the disclosure as defined by the claims.

What is claimed is:

1. A data processing method of a storage device, comprising:
receiving a query request from a host;
determining whether a computing resource in the storage device is saturated;
determining whether the storage device is needed to perform a scan-filter operation corresponding to the query request, based on a determination that the computing resource in the storage device is not saturated;
performing the scan-filter operation on raw data in the storage device to obtain processed data, based on a determination that the storage device is needed to perform the scan-filter operation; and
transmitting the processed data to the host.

2. The data processing method of claim 1, wherein the determining of whether the computing resource in the storage device is saturated comprises:
detecting whether a scan queue in the storage device is full;
determining that the computing resource in the storage device is saturated based on the scan queue being full; and
determining that the computing resource in the storage device is not saturated, based on the scan queue not being full.

3. The data processing method of claim 2, wherein the determining of whether the computing resource in the storage device is saturated comprises:
detecting whether a utilization rate of the computing resource in the storage device is greater than or equal to a first threshold value;
determining that the computing resource in the storage device is saturated, based on the utilization rate of the computing resource in the storage device being greater than or equal to the first threshold; and
determining that the computing resource in the storage device is not saturated, based on the utilization rate of the computing resource in the storage device being less than the first threshold value.

4. The data processing method of claim 3, wherein the determining of whether the storage device is needed to perform the scan-filter operation comprises:
randomly sampling a plurality of data from the storage device to obtain a plurality of sampled data;
performing filtering on the plurality of sampled data using a filtering algorithm to obtain a plurality of filtered data;
determining a filtering rate based on a ratio of a number of the plurality of filtered data to a number of the plurality of sampled data;
determining that the storage device is not needed to perform the scan-filter operation, based on the filtering rate being greater than or equal to a second threshold value; and
determining that the storage device is needed to perform the scan-filter operation, based on the filtering rate being less than the second threshold value.

5. The data processing method of claim 3, wherein the query request comprises a first query request for performing a first scan-filter task, and
wherein the performing of the scan-filter operation on the raw data in the storage device comprises:
placing the first scan-filter task into a scan queue in the storage device, and performing a first scan operation on first raw data corresponding to the first scan-filter task to obtain first scanned data using the computing resource in the storage device;
after completing the first scanning operation, placing the first scanned data into a filtering queue, and performing a first filtering operation on the first scanned data to obtain first filtered data using the computing resource in the storage device; and
after completing the first filtering operation, placing the first filtered data into a result queue to obtain first processed data.

6. The data processing method of claim 5, wherein the query request further comprises a second query request for performing a second scan-filter task, and
wherein the performing of the scan-filter operation on the raw data in the storage device comprises:
after completing the first scanning operation, placing the second scan-filter task into the scan queue in the storage device, and performing a second scan operation on second raw data corresponding to the second scan-filter task to obtain second scanned data using the computing resource in the storage device;
after completing the second scanning operation, placing the second scanned data into the filtering queue, and performing a second filtering operation on the second scanned data to obtain second filtered data using the computing resource in the storage device; and
after completing the second filtering operation, placing the second filtered data into the result queue to obtain second processed data.

7. The data processing method of claim 5, wherein the transmitting of the processed data to the host comprising:
transmitting the first processed data in the result queue to the host.

8. The data processing method of claim 1, further comprising:
transmitting the raw data in the storage device to the host, based on a determination that the computing resource in the storage device is saturated.

9. The data processing method of claim 8, further comprising:
transmitting the raw data in the storage device to the host, based on a determination that the storage device is not needed to perform the scan-filter operation.

10. A storage device, comprising:
a computing resource;
a memory storing one or more instructions;
a processor configured to execute the one or more instructions to:
receive a query request from a host;
determine whether the computing resource in the storage device is saturated; and
determine whether the storage device is needed to perform a scan-filter operation corresponding to the query request, based on a determination that the computing resource in the storage device is not saturated;
the computing resource configured to perform the scan-filter operation on raw data in the storage device to obtain processed data, based on a determination that the storage device is needed to perform the scan-filter operation; and
a transmitter configured to transmit the processed data to the host.

11. The storage device of claim 10, wherein the processor is further configured to:
detect whether a scan queue in the storage device is full;
determine that the computing resource in the storage device is saturated, based on the scan queue being full; and
determine that the computing resource in the storage device is not saturated, based on the scan queue not being full.

12. The storage device of claim 11, wherein the processor is further configured to:
detect whether a utilization rate of the computing resource in the storage device is greater than or equal to a first threshold value;
determine that the computing resource in the storage device is saturated, based on the utilization rate of the computing resource in the storage device being greater than or equal to the first threshold; and
determine that the computing resource in the storage device is not saturated, based on the utilization rate of the computing resource in the storage device being less than the first threshold value.

13. The storage device of claim 12, wherein the processor is further configured to:
randomly sample a plurality of data from the storage device to obtain a plurality of sampled data;
perform filtering on the plurality of sampled data using a filtering algorithm to obtain a plurality of filtered data;
determine a filtering rate based on a ratio of a number of the plurality of filtered data to a number of the plurality of sampled data;
determine that the storage device is not needed to perform the scan-filter operation, based on the filtering rate being greater than or equal to a second threshold value; and
determine that the storage device is needed to perform the scan-filter operation, based on the filtering rate being less than the second threshold value.

14. The storage device of claim 12, wherein the query request comprises a first query request involving a first scan-filter task, and
wherein the computing resource is configured to:
place the first scan-filter task into a scan queue in the storage device, and perform a first scan operation on first raw data corresponding to the first scan-filter task to obtain first scanned data using the computing resource in the storage device;
after completing the first scanning operation, place the first scanned data into a filtering queue, and perform a first filtering operation on the first scanned data to obtain first filtered data using the computing resource in the storage device; and
after completing the first filtering operation, place the first filtered data into a result queue to obtain first processed data.

15. The storage device of claim 14, wherein the query request further comprises a second query request involving a second scan-filter task, and
wherein the computing resource is configured to:
after completing the first scanning operation, place the second scan-filter task into the scan queue in the storage device, and perform a second scan operation on second raw data corresponding to the second scan-filter task to obtain second scanned data using the computing resource in the storage device;
after completing the second scanning operation, place the second scanned data into the filtering queue, and perform a second filtering operation on the second scanned data to obtain second filtered data using the computing resource in the storage device; and
after completing the second filtering operation, place the second filtered data into the result queue to obtain second processed data.

16. The storage device of claim 14, wherein the transmitter is configured to:
transmit the first processed data in the result queue to the host.

17. The storage device of claim 10, wherein the transmitter is further configured to:
transmit the raw data in the storage device to the host, based on a determination that the computing resource in the storage device is saturated.

18. The storage device of claim 17, wherein the transmitter is further configured to:
transmit the raw data in the storage device to the host, based on a determination that the storage device is not needed to perform the scan-filter operation.

19. A data processing method of a host, comprising:
transmitting a query request to a storage device, the query request comprising a plurality of tasks, the plurality of tasks comprising a scan-filter task;
receiving data corresponding to the query request from the storage device;
determining whether the data is raw data or scanned-filtered data;
based on a determination that the data is the scanned-filtered data, performing remaining tasks of the plurality of tasks other than the scan-filter task, on the data; and
based on a determination that the data is the raw data, performing the scan-filter task on the data and performing the remaining tasks on the data for which the scan-filter task is performed.

20. The storage device of claim 19, wherein the transmitting of a query request to a storage device comprises:
converting a format of the query request to a format compatible with the storage device; and
transmitting a format-converted query request to the storage device.
